(19) United States
(12) Patent Application Publication
(10) Pub. No.: US 2015/0120605 A1
(43) Pub. Date: Apr. 30, 2015

(54) VIRTUAL DATA WRITE-BACK FOR BUSINESS INTELLIGENCE REPORTING

(71) Applicant: International Business Machines Corporation, Armonk, NY (US)

(72) Inventors: George Jijiang Xu, Ottawa (CA); Tom Xu Wu, Ottawa (CA)

(21) Appl. No.: 14/308,274

(22) Filed: Jun. 18, 2014

Related U.S. Application Data
(63) Continuation of application No. 14/069,055, filed on Oct. 31, 2013.

(51) Int. Cl. G06Q 10/06

(52) U.S. Cl. CPC G06Q 10/063
USPC 705/342

(57) ABSTRACT

Techniques enable virtual data write-back in business intelligence (BI) reporting. In one example, a method includes outputting an initial version of a business intelligence (BI) report, wherein the BI report comprises a first field and a first BI report element. The first field displays a first item of data from a first data source. The first BI report element is based at least in part on the first item of data. The method includes receiving an input indicating a modified form of the first item of data. The method includes generating a revised form of the first BI report element based in part on the modified form of the first item of data. The method includes outputting a revised version of the BI report comprising the modified form of the first item of data in the first field and the revised form of the first BI report element.

This application is a continuation of Ser. No. 14/069,055, filed on Oct. 31, 2013 entitled VIRTUAL DATA WRITE-BACK FOR BUSINESS INTELLIGENCE REPORTING, the entire content of which is incorporated herein by reference.

### TECHNICAL FIELD

This disclosure relates to business intelligence systems, and more particularly, to entering data for business intelligence reporting.

### BACKGROUND

Enterprise software systems are typically sophisticated, large-scale systems that support many, e.g., hundreds or thousands, of concurrent users. Examples of enterprise software systems include financial planning systems, budget planning systems, order management systems, inventory management systems, sales force management systems, business intelligence tools, enterprise reporting tools, project and resource management systems, and other enterprise software systems.

Many enterprise performance management and business planning applications require a large base of users to enter data that the software then accumulates into higher level areas of responsibility in the organization. Moreover, once data has been entered, it must be retrieved to be utilized. The system may perform mathematical calculations on the data, combining data submitted by many users. Using the results of these calculations, the system may generate reports for review by higher management. Often these complex systems make use of multidimensional data sources that organize and manipulate the tremendous volume of data using data structures referred to as data cubes. Each data cube, for example, includes a plurality of hierarchical dimensions having levels and members for storing the multidimensional data.

Business intelligence (BI) systems may be used to provide insights into such collections of enterprise data. Users may use reporting tools to generate BI reports based on the collections of enterprise data. A generated report may typically include large amounts of aggregated information in any of various electronic formats or a paper format. A user may subsequently add or revise data among the underlying data sources, e.g., through an extract-transform-load (ETL) process of the applicable data source, or through an application user interface of the applicable data source.

### SUMMARY

In general, examples disclosed herein are directed to techniques for enabling virtual data write-back in a business intelligence (BI) report. In one example, a method for enabling virtual data write-back in a BI reporting tool includes outputting an initial version of a business intelligence (BI) report, wherein the BI report comprises a first field and a first BI report element, such that the first field displays a first item of data from a first data source, and the first BI report element is based at least in part on the first item of data. The method further includes receiving an input indicating a modified form of the first item of data. The method further includes generating a revised form of the first BI report element based at least in part on the modified form of the first item of data. The method further includes outputting a revised version of the BI report comprising the modified form of the first item of data in the first field and the revised form of the first BI report element.

In another example, a computer program product for enabling virtual data write-back in a business intelligence (BI) report includes a computer-readable storage medium having program code embodied therewith. The program code is executable by a computing device to output an initial version of a business intelligence (BI) report, wherein the BI report comprises a first field and a first BI report element, such that the first field displays a first item of data from a first data source, and the first BI report element is based at least in part on the first item of data. The program code is further executable by a computing device to receive an input indicating a modified form of the first item of data. The program code is further executable by a computing device generate a revised form of the first BI report element based at least in part on the modified form of the first item of data. The program code is further executable by a computing device output a revised version of the BI report comprising the modified form of the first item of data in the first field and the revised form of the first BI report element.

In another example, a computer system for enabling virtual data write-back in a business intelligence (BI) report includes one or more processors, one or more computer-readable memories, and one or more computer-readable, tangible storage devices. The computer system further includes program instructions, stored on at least one of the one or more storage devices for execution by at least one of the one or more processors via at least one of the one or more memories, to output an initial version of a business intelligence (BI) report, wherein the BI report comprises a first field and a first BI report element, such that the first field displays a first item of data from a first data source, and the first BI report element is based at least in part on the first item of data. The computer system further includes program instructions, stored on at least one of the one or more storage devices for execution by at least one of the one or more processors via at least one of the one or more memories, to receive an input indicating a modified form of the first item of data. The computer system further includes program instructions, stored on at least one of the one or more storage devices for execution by at least one of the one or more processors via at least one of the one or more memories, to generate a revised form of the first BI report element based at least in part on the modified form of the first item of data. The computer system further includes program instructions, stored on at least one of the one or more storage devices for execution by at least one of the one or more processors via at least one of the one or more memories, to output a revised version of the BI report comprising the modified form of the first item of data in the first field and the revised form of the first BI report element.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example enterprise having a computing environment in which users interact with an enterprise business intelligence (BI) system and data sources accessible over a public network.

FIG. 2 is a block diagram illustrating one embodiment of an enterprise business intelligence computing environment including a system for enabling virtual data write-back in a BI report as part of a BI computing system.

FIG. 3 is a screenshot of a BI reporting user interface (UI) for a BI reporting tool functioning in a design mode, in one example.

FIG. 4 is a screenshot of a BI reporting user interface (UI) for a BI reporting tool functioning in a runtime mode, according to one example.

FIG. 5 depicts a conceptual diagram of a BI metadata model as a context in which a BI reporting tool may function, according to one example.

FIG. 6 depicts a conceptual diagram of an operational environment for a BI reporting tool to execute a BI report, according to one example.

FIG. 7 depicts a conceptual diagram of an operational environment for a BI reporting tool to execute a BI report, according to one example.

FIG. 8 depicts a data structure diagram for a data write-back service of this disclosure, according to one example.

FIG. 9 depicts a flowchart for an example overall process for enabling virtual data write-back in a BI report in a BI system.

FIG. 10 is a block diagram of an example computing device that may execute a system for enabling virtual data write-back in a BI report as part of a BI computing system.

### DETAILED DESCRIPTION

Various examples are disclosed herein for enabling virtual data write-back in a business intelligence (BI) report. In various examples, a BI reporting tool may enable data fields in a BI report to be user-editable, and may store the user-modified data and re-run the BI report based on the user-modified data inputs, without altering the original data in the underlying data sources. In general, a BI reporting tool of this disclosure may be modified to add enhanced query attributes that can maintain virtual data write-back. The enhanced query attributes can accept and maintain additions or revisions entered by a user to any data incorporated in a BI report. A BI reporting tool of this disclosure can then expose those additions or revisions to the data incorporated in the BI report from the enhanced query attributes as if the added or revised data were incorporated in the underlying data sources.

A BI reporting tool of this disclosure may provide this appearance of updating the data sources in the BI report without having to undertake the complexity of actually locating and altering the data in the underlying data sources and then retrieving newly altered data from those data sources. A BI reporting tool of this disclosure may also enable updates in data in a BI report without requiring data entry via a separate extract-transform-load (ETL) process or application user interface of individual applicable data sources. A BI reporting tool of this disclosure may further enable saving and sharing updated BI reports, where the BI report persistently maintains updated data within the query attribute layer of the BI reporting tool with the appearance of changes in data made to the underlying data sources.

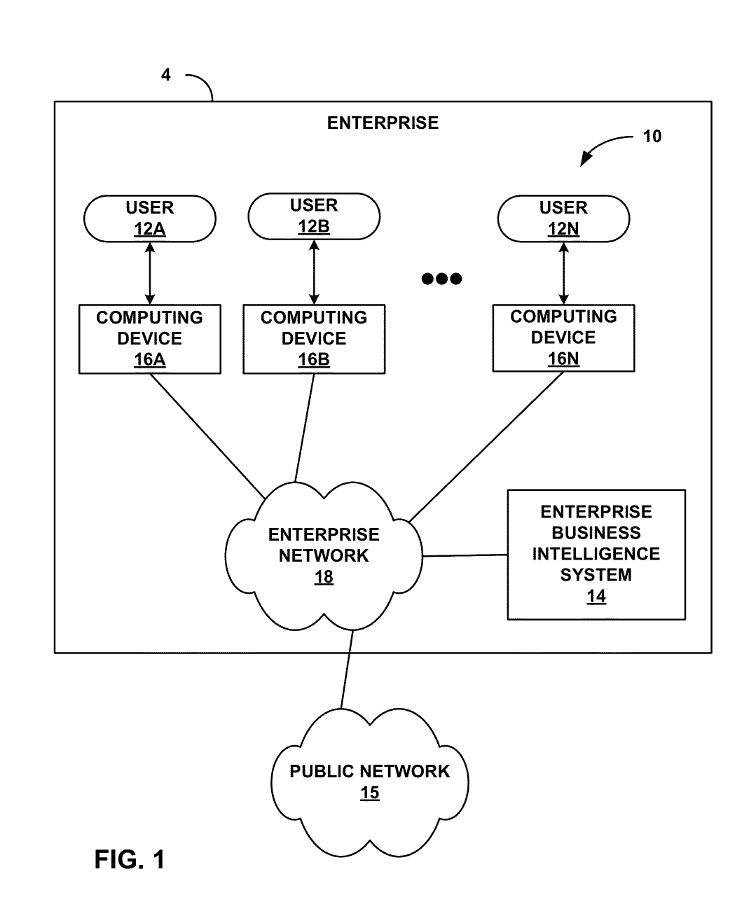

FIG. 1 illustrates an example context in which a system of this disclosure may be used. FIG. 1 is a block diagram illustrating an example enterprise 4 having a computing environment 10 in which a plurality of users 12A-12N (collectively, “users 12”) may interact with an enterprise BI system 14. In the system shown in FIG. 1, enterprise business intelligence system 14 is communicatively coupled to a number of client computing devices 16A-16N (collectively, “client computing devices 16” or “computing devices 16”) by an enterprise network 18. Users 12 interact with their respective computing devices to access enterprise business intelligence system 14. Users 12, computing devices 16A-16N, enterprise network 18, and enterprise business intelligence system 14 may all be either in a single facility or widely dispersed in two or more separate locations anywhere in the world, in different examples.

For exemplary purposes, various examples of the techniques of this disclosure may be readily applied to various software systems, including enterprise business intelligence systems or other large-scale enterprise software systems. Examples of enterprise software systems include enterprise financial or budget planning systems, order management systems, inventory management systems, sales force management systems, business intelligence tools, enterprise reporting tools, project and resource management systems, and other enterprise software systems.

In this example, enterprise BI system 14 includes servers that run BI dashboard web applications and may provide business analytics software. A user 12 may use a BI portal on a client computing device 16 to view and manipulate information such as business intelligence reports (“BI reports”) and other collections and visualizations of data via their respective computing devices 16. This may include data from any of a wide variety of sources, including from multidimensional data structures and relational databases within enterprise 4, as well as data from a variety of external sources that may be accessible over public network 15.

Users 12 may use a variety of different types of computing devices 16 to interact with enterprise business intelligence system 14 and access data visualization tools and other resources via enterprise network 18. For example, an enterprise user 12 may interact with enterprise business intelligence system 14 and run a business intelligence (BI) portal (e.g., a business intelligence dashboard) using a laptop computer, a desktop computer, or the like, which may run a web browser. Alternatively, an enterprise user may use a smartphone, tablet computer, or similar device, running a business intelligence dashboard in a web browser, a dedicated mobile application, or other means for interacting with enterprise business intelligence system 14.

Enterprise network 18 and public network 15 may represent any communication network, and may include a packet-based digital network such as a private enterprise intranet or a public network like the Internet. In this manner, computing environment 10 can readily scale to suit large enterprises. Enterprise users 12 may directly access enterprise business intelligence system 14 via a local area network, or may remotely access enterprise business intelligence system 14 via a virtual private network, remote dial-up, or similar remote access communication mechanism.

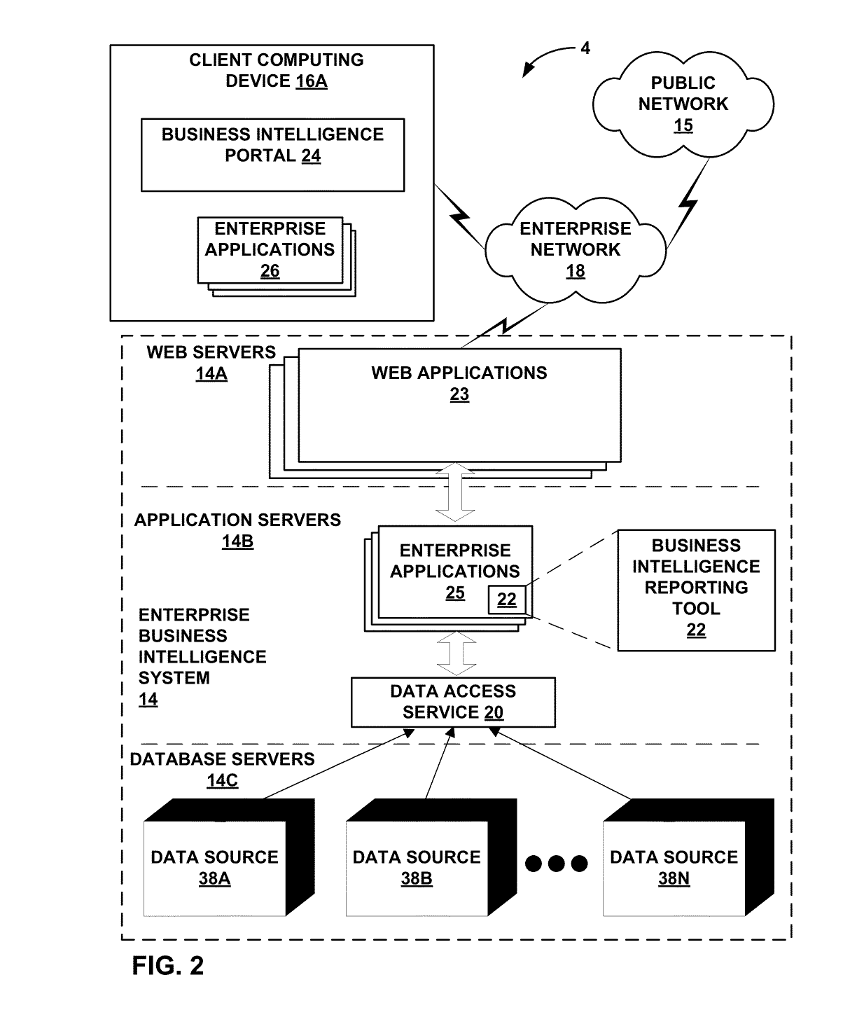

FIG. 2 is a block diagram illustrating in further detail portions of one embodiment of an enterprise business intelligence (BI) system 14. In this example implementation, a single client computing device 16A is shown for purposes of example and includes a BI portal 24 and one or more client-side enterprise software applications 26 that may utilize and manipulate multidimensional data, including viewing data visualizations and analytical tools with BI portal 24. BI portal 24 may be rendered within a general web browser application, within a locally hosted application or mobile application, or other user interface. BI portal 24 may be generated or rendered using any combination of application software and data local to the computing device it's being generated on, and/or remotely hosted in one or more application servers or other remote resources.

BI portal 24 may output data visualizations for a user to view and manipulate in accordance with various techniques described in further detail below. BI portal 24 may present data in the form of charts or graphs that a user may manipulate, for example. BI portal 24 may present visualizations of data based on data from sources such as a BI report, e.g., that may be generated with enterprise business intelligence system 14, or another BI dashboard, as well as other types of data sourced from external resources through public network 15. BI portal 24 may present visualizations of data based on data that may be sourced from within or external to the enterprise.

FIG. 2 depicts additional detail for enterprise business intelligence system 14 and how it may be accessed via interaction with a BI portal 24 for depicting and providing visualizations of business data. BI portal 24 may provide visualizations of data that represents, provides data from, or links to any of a variety of types of resource, such as a BI report, a software application, a database, a spreadsheet, a data structure, a flat file, Extensible Markup Language (“XML”) data, a comma separated values (CSV) file, a data stream, unorganized text or data, or other type of file or resource. BI portal 24 may also provide visualizations of data in a BI report with editable data fields enabled with virtual data write-back operated by a BI reporting tool 22, for example.

BI reporting tool 22 may be hosted among enterprise applications 25, as in the example depicted in FIG. 2, or may be hosted elsewhere, including on a client computing device 16A, or distributed among various computing resources in enterprise business intelligence system 14, in some examples. BI reporting tool 22 may be implemented as or take the form of a stand-alone application, a portion or add-on of a larger application, a library of application code, a collection of multiple applications and/or portions of applications, or other forms, and may be executed by any one or more servers, client computing devices, processors or processing units, or other types of computing devices.

As depicted in FIG. 2, enterprise business intelligence system 14 is implemented in accordance with a three-tier architecture: (1) one or more web servers 14A that provide web applications 23 with user interface functions, including a server-side BI portal application 21; (2) one or more application servers 14B that provide an operating environment for enterprise software applications 25 and a data access service 20; and (3) database servers 14C that provide one or more data sources 38A, 38B, . . . , 38N (“data sources 38”). Enterprise software applications 25 may include BI reporting tool 22 as one of enterprise software applications 25 or as a portion or portions of one or more of enterprise software applications 25. The data sources 38 may include two-dimensional databases and/or multidimensional databases or data cubes. The data sources may be implemented using a variety of vendor platforms, and may be distributed throughout the enterprise. As one example, the data sources 38 may be multidimensional databases configured for Online Analytical Processing (OLAP). As another example, the data sources 38 may be multidimensional databases configured to receive and execute Multidimensional Expression (MDX) queries of some arbitrary level of complexity. As yet another example, the data sources 38 may be two-dimensional relational databases configured to receive and execute SQL queries, also with an arbitrary level of complexity. Data sources 38 may also include one or more sets of operational data 36 (e.g., business data or proprietary data) and one or more sets of geographical data 37 (e.g., public geographical data, custom business geographical data).

Multidimensional data structures are “multidimensional” in that each multidimensional data element is defined by a plurality of different object types, where each object is associated with a different dimension. The enterprise applications 26 on client computing device 16A may issue business queries to enterprise business intelligence system 14 to build reports. Enterprise business intelligence system 14 includes a data access service 20 that provides a logical interface to the data sources 38. Client computing device 16A may transmit query requests through enterprise network 18 to data access service 20. Data access service 20 may, for example, execute on the application servers intermediate to the enterprise software applications 25 and the underlying data sources in database servers 14C. Data access service 20 retrieves a query result set from the underlying data sources, in accordance with query specifications. Data access service 20 may intercept or receive queries, e.g., by way of an API presented to enterprise applications 26. Data access service 20 may then return this result set to enterprise applications 26 as BI reports, other BI objects, and/or other sources of data that are made accessible to BI portal 24 on client computing device 16A. These may include BI reports generated by BI reporting tool 22 that include data from one or more underlying data sources. BI reporting tool 22 may enable one or more fields of a BI report to be user-editable, such that BI reporting tool 22 saves user-modified data entries in a virtual data write-back location without affecting the original data in the underlying data sources, as further described below.

Example embodiments of the present disclosure, such as BI reporting tool 22 depicted in FIG. 2, may enable virtual data write-back in a BI report. As described above and further below, BI reporting tool 22 may be implemented in one or more computing devices, and may involve one or more applications or other software modules that may be executed on one or more processors. Example embodiments of the present disclosure may illustratively be described in terms of the example of BI reporting tool 22 in various examples described below. BI reporting tool 22 may enable one or more fields of a BI report to be user-editable, saving user-modified data in a virtual data write-back layer, and re-generating data visualizations in the BI report in accordance with the user-modified data.

Various implementations of BI reporting tool 22 of this disclosure may have the following example advantages. BI reporting tool 22 may be fully dynamic, such that a user of BI reporting tool 22 in design mode can easily designate a cell in a BI report as data write-back capable. BI reporting tool 22 may include robust built-in data write-back logic. This data write-back logic may free application developers from acquiring additional domain knowledge such as data procedure programming, software development kit (SDK) development, or data entry form development, for example. BI reporting tool 22 may save a customer from having to set up a separate system for data entry or changes. BI reporting tool 22 may also enable real-time updating of data write-back modifications in one instance of a BI report among other instances of the same BI report shared among other users.

BI reporting tool 22 may also enable virtual data write-back consistently within the context of other platform features and properties, including a secured environment, built-in scalability features, and support for a wide variety of BI report formats, for example. A secured environment for BI reporting tool 22 may include user authentication and access control, for example. Built-in scalability features for BI reporting tool 22 may include load balance and fail-over with distributed services, for example. BI report formats supported by BI reporting tool 22 may include Portable Document Format (PDF), Hypertext Markup Language (HTML), Comma-Separated Values (CSV), and spreadsheet file formats, for example. For purposes of this disclosure, a cell of a BI report may be said to be “data writable” in that BI reporting tool 22 enables a virtual data write-back function in that cell. Such a cell may also similarly be described as “data updatable,” “data editable,” and “data write-back capable.”

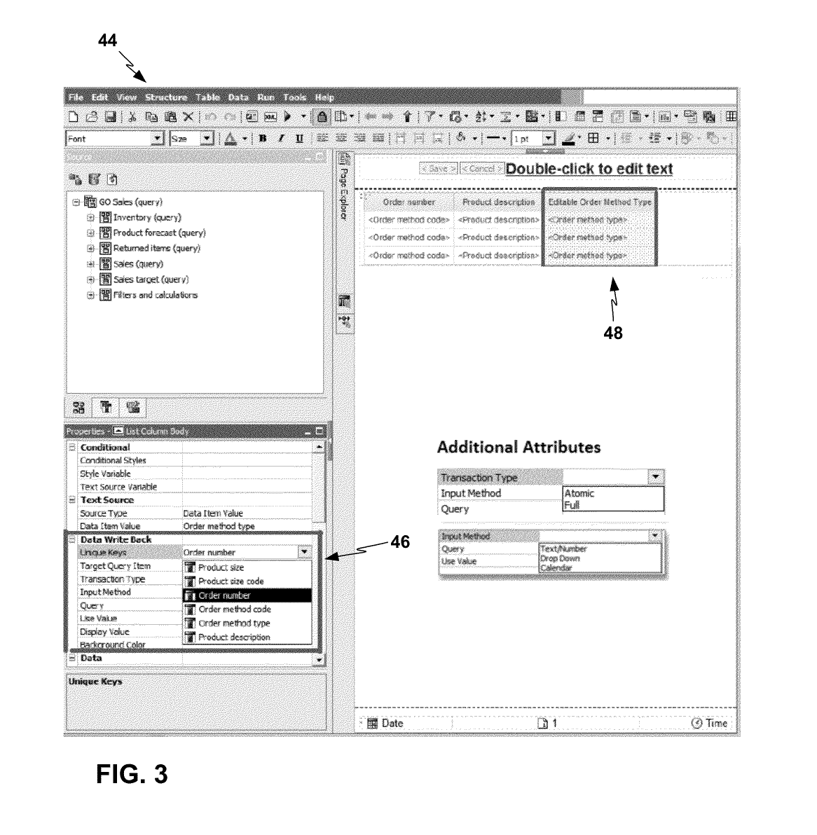

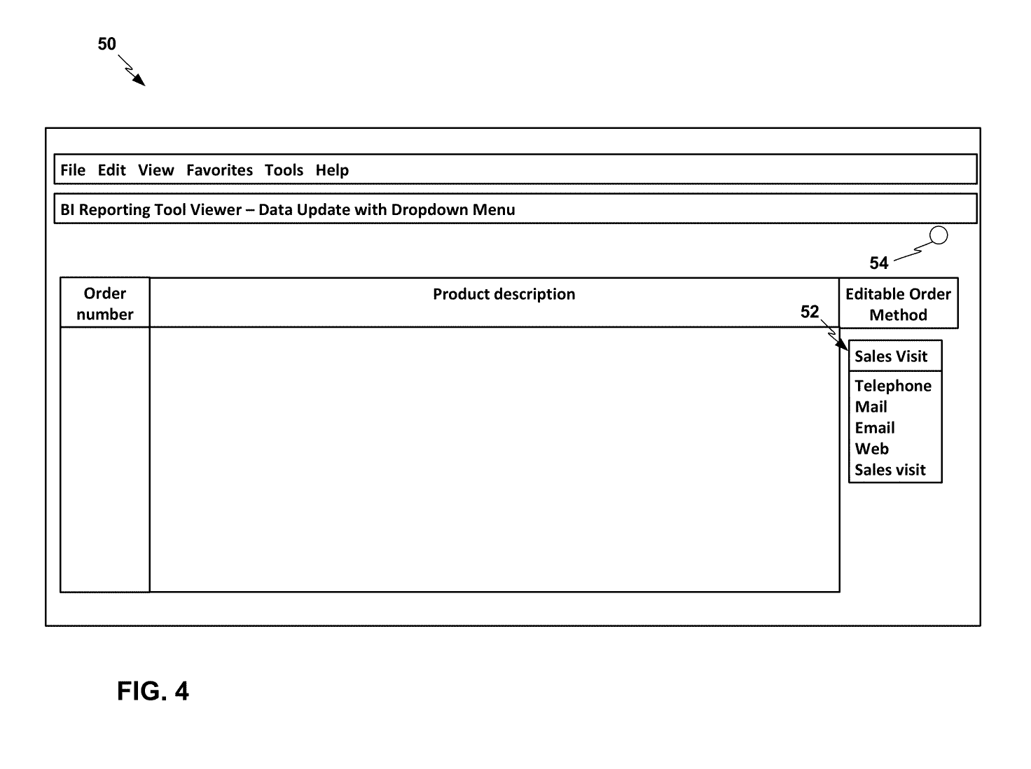

BI reporting tool 22 may function in both a design mode, for designing a BI report, and a run time mode, for consuming a BI report. Examples of BI reporting tool 22 functioning in the design mode and the runtime mode are depicted in FIG. 3 and FIG. 4, respectively.

FIG. 3 is a screenshot of a BI reporting user interface (UI) 44 for BI reporting tool 22 functioning in a design mode, according to one example. As shown in FIG. 3, a design mode UI of BI reporting tool 22 may include a layout of a BI report specification. The BI reporting tool 22 may render the design mode UI in a browser application or in a dedicated reporting tool application, in various examples. The UI 44 for BI reporting tool 22 may include data write-back tables 46, 48 to specify unique keys to designate particular data fields to be user-editable, and to receive user-modified inputs to store in a virtual data write-back location. In the design mode, a user functioning as a BI report author may specify what context is needed to enable the data write-back on a particular data item in the report specification. The report rendering service component may read the specification and generate an event in the report output, such as by using JavaScript, according to one example. Further example implementations may be described in terms of BI reporting tool 22 using JavaScript events, with the understanding that similar functions may be implemented using other technologies in other examples.

When a user makes modifications in the BI reporting design mode UI, BI reporting tool 22 may use JavaScript events to track the user modifications at the client side and store the modifications in a local memory block. When the user inputs a save command (e.g., clicks a save button), BI reporting tool 22 may send the user modifications to a data update service responsible for submitting the user modifications into a database or other data source, in some examples. BI reporting tool 22 may include properties for one or more editable data items in the layout of the report specification in the design mode UI, as shown in FIG. 3. In this example, BI reporting tool 22 includes the properties “unique keys” and “write-back query item”. The unique keys identify the editable data, and therefore uniquely define how the data should be written back to the database. The write-back query item identifies which call destination to write-back. FIG. 3 also shows other helper properties, such as transaction type, input type, and background color. If it is a drop down list, a separate query will be provided with “display value” and “use value”.

FIG. 4 is a screenshot of a BI reporting user interface (UI) 50 for BI reporting tool 22 functioning in a runtime mode, according to one example. When a data item is defined as data write-back capable, it is marked with “editable” in HTML. Users can change data or select data from a data field 52 in the form of a drop-down list, as shown in FIG. 4. Drop-down list 52 is one example of a user-editable data field. Any type of data field in a BI report may also be a user-editable data field enabled by BI reporting tool 22 to receive user modifications of data, in other examples. BI reporting tool 22 may use JavaScript events attached to these editable fields to track changes made by a user. When a user inputs a save command (e.g., clicks a save button 54), BI reporting tool 22 may send the collected changes to the data update service for database submission.

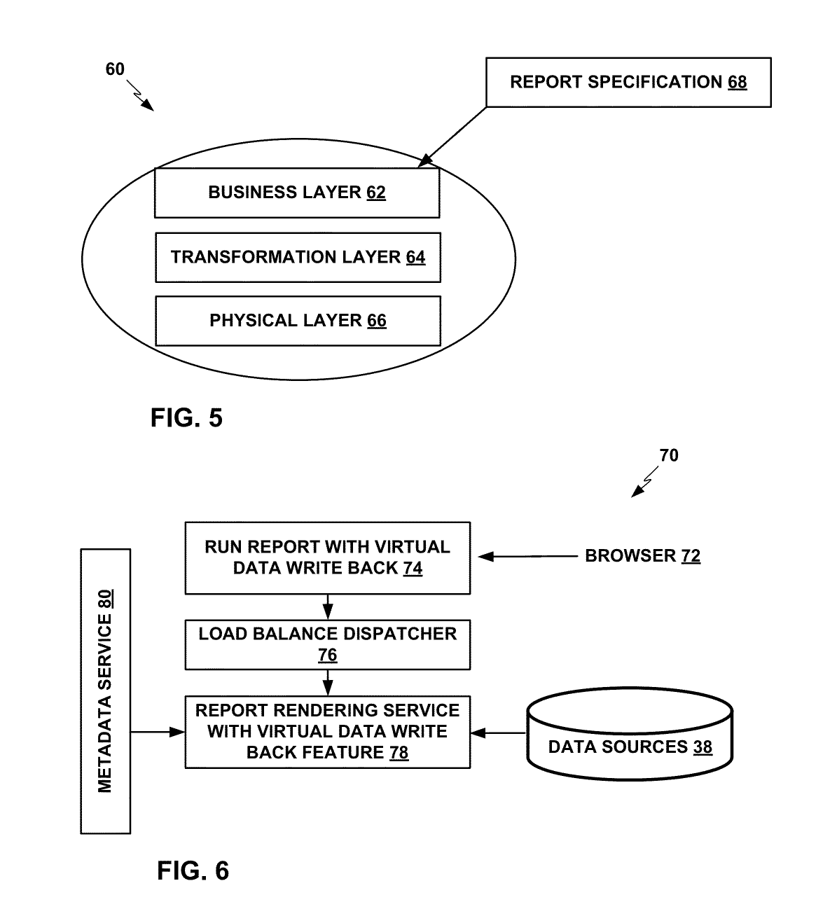

FIG. 5 depicts a conceptual diagram of a BI metadata model 60 as a context in which a BI reporting tool 22 may function, according to one example. The BI metadata model has a three-tiered abstraction layer, with a business layer 62 served by an underlying transformation layer 64, and the transformation layer 64 served by an underlying physical layer 66. The BI metadata model also has a report specification 68 that references to the business layer 62.

The physical layer 66 may represent a database physical layout, such as database table name and column names. The transformation layer 64 may convert the physical table and columns to data warehouse forms such as measures and dimensions. The business layer 62 may hide physical table and column names and present more human readable names to a report author. A report specification 68 may have information such as layout, prompts, and queries, etc. Each of these components of the report specification 68 may have references to objects in the business layer 62 with no direct reference to the physical layer.

FIG. 6 depicts a conceptual diagram of an operational environment 70 for BI reporting tool 22 to execute a BI report, according to one example. When a user runs a report from a browser 72, a BI reporting tool client-side interface 74 may send a request to a load balance dispatcher 76 which routes the request to a report rendering service 78 of BI reporting tool 22. The report rendering service 78 of BI reporting tool 22 may use a related metadata service 80 and the report data source 38 (as in FIG. 2) to produce report output and send the report output back to the browser 72.

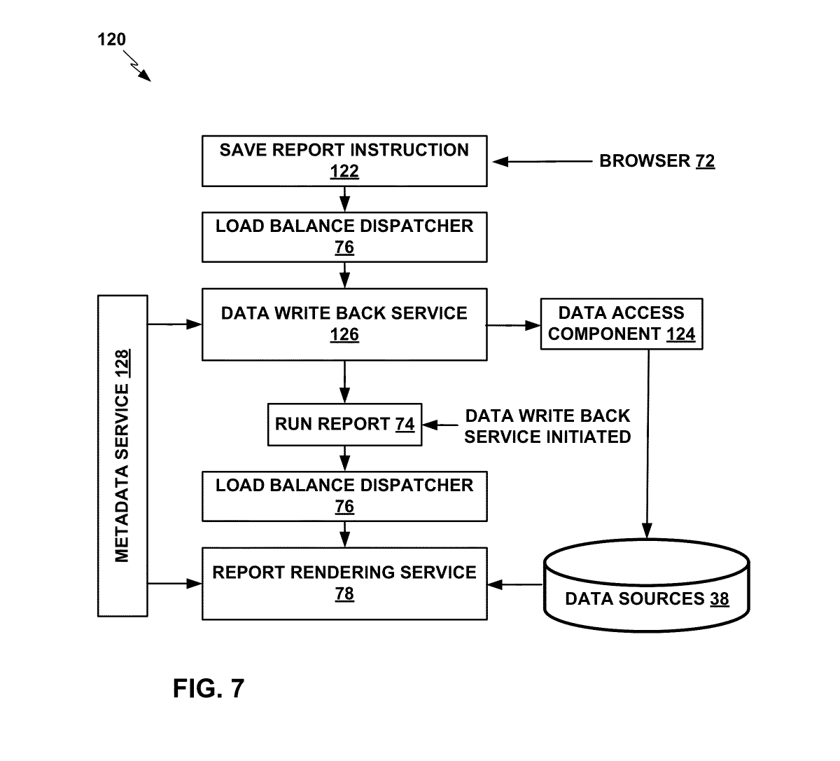

BI reporting tool 22 may use a data write-back process flow as in the following example. Running a data write-back capable BI report may have a similar process in some ways as running a traditional read-only BI report, though the report rendering service may also be enhanced with data write-back features. Based on the report specification, the data write-back report rendering service may generate report output which has JavaScript and events built-in to track changes to data fields as entered by a user, as shown in FIG. 7.

FIG. 7 depicts a conceptual diagram of an operational environment 120 for BI reporting tool 22 to execute a BI report, according to one example. When BI reporting tool 22 receives a “save” instruction 122 from browser 72, the load balancer 76 may re-direct the request to a data write-back service 126. The data write-back service 126 may analyze the business layer query based change context utilizing a metadata service 128 to generate a SQL query. The data write-back service 126 may then send the SQL update to a data access component 124 (e.g., a data access application programming interface (API)) to commit the change. Once the data is written back, the data write-back service 126 may send a BI report run request 74 to the report rendering service 78. The report rendering service 78 may generate output with new data in the data source 38 or from an alternate data source, depending on the report query item expression, and send the output back to the browser 72. BI reporting tool 22 of this disclosure may thus include a data write-back report specification, data write-back capable report output, and data write-back service.

An example of a data write-back report specification of this disclosure is further described as follows. As described above, a BI reporting tool 22 of this disclosure may include unique keys and a target data column in the report specification. These two properties in the data item may help identify a data change, and where to write the data change back into the data source. The unique keys may be used as an indication for a data write-back capable report. When the report rendering service receives a run report request with unique keys, the report rendering service may generate a data write-back capable report output. The content of the report output is further described below.

The unique keys have attributes that includes the source primary keys and the target primary keys. The keys are used to uniquely identify a row in the database. The source keys tell where to get the key values. The target primary keys imply where to store the data because of their association with a database table and columns. The target data column defines the data column to write back to.

When the source and target keys are the same, the data is implied to be written back to the same table defined by the source keys. When the source and target keys are different, the key values from the source columns may be used to update rows in the tables that the target primary keys associate with. The target data item may be the same as the current data item, or may be undefined. The data may then be written back to the table column the current data item is associated with. When the target data item is different than the current data item, the data may be written back to a different location and the target data item may be associated with this different location, maintaining the virtual write-back. The data modeler may select locations for a virtual write-back, while the different virtual write-back locations may not necessarily be apparent to a report author.

In the following example, the primary key values are from source primary keys, e.g., [Query1].[Order ID] and [Query1].[Order Item ID]. These values are used as primary keys for the data write-back. BI reporting tool 22 may use unique expressions to resolve locations of the data in the data sources, such as database columns, data cubes, storage as a service, etc., for these key values. In a database example, BI reporting tool 22 may resolve database columns from query item [Query1].[Aux Order ID], [Query1].[Aux Order Item ID]. In a dimensional model, BI reporting tool 22 may resolve a data source location using a member unique name (MUN). BI reporting tool 22 may write user modifications to an editable report field to a database column associated with [Query1].[AUX Order Method Code]. The source is implied to be [Query1].[Order Method Code] as it is the data item.

TABLE 1

| Data Item | | |
|---|---|---|
| Attribute | Description | |
| Unique Keys | Source Primary Keys | Target Primary Keys |
| | [Query1].[Order ID] | [Query1].[Aux Order ID] |
| | [Query1].[Order Item ID] | [Query1].[Aux Order Item ID] |

| | |
|---|---|
| Target Data | [Query1].[AUX Order Method Code] |
| Column | |

Since the definition is query based, it can be uniquely associated with physical database fields, or derived from an expression. This is applicable to both the source data and target data. Additional usage examples are described as follows. One example use case for virtual data write-back is illustrated below in Table 2.

TABLE 2

| | Name | Expression |
|---|---|---|
| Source | [Query1].[Order | if ([Query1].[ AUX Order Method Code] is not |
| Query Item | Method Code] | null) then |
| | | [Query1].[ AUX Order Method Code]; |
| | | else |
| | | [Query1].[Order Method Code]; |
| | | end if |
| Target | [Query1].[ AUX | [Query1].[ AUX Order Method Code] |
| Query Item | Order Method Code] | |

In this example, the data write-back source is from [Query1].[Order Method Code], which is based on an expression and can be from two locations. The write-back target is [Query1].[AUX Order Method Code]. When a user first runs the report, [AUX Order Method Code] is empty, and the data is read from [Order Method Code]. After the user makes a change to an editable report field and saves the change, BI reporting tool 22 writes the data [AUX Order Method Code]. When the user run the report again, the source is now from [AUX Order Method Code], not [Order Method Code]. Thereafter, the change will always be made into [AUX Order Method Code], not [Order Method Code]. [Order Method Code] is only used for read in this process. BI reporting tool 22 of this disclosure may thus provide data write-back without actually writing data back to the original source, or in other words, a virtual data write-back. In some examples, a metadata modeler can build the expression into the metadata model, thereby enabling a report author to perform virtual data write-back without requiring an understanding of query expressions.

Another example use case for virtual data write-back is illustrated below in Table 3. This use case includes writing to a different target table structure, in what may be referred to as a virtual structure write-back. In this example, BI reporting tool 22 does not require the data write target table to have the same structure as the source data table. The target data column may be defined as follows in Table 3:

TABLE 3

| Data Item | | |
|---|---|---|
| Attribute | Description | |
| Unique Keys | Source Primary Keys | Target Primary Keys |
| | [Query1].[Order ID] + ‘-’ + | [Query1].[Aux Order ID] |
| | [Query1].[Order Item ID] | |

| | |
|---|---|
| Target Data | [Query1].[AUX Order Method Code] |
| Column | |

In this example, the target table has only one key, which is a concatenation of two keys from the source. The target table key may be a concatenation of any number of keys from a first or original data source, or from multiple data sources including the first data source, in various examples.

Another example use case for virtual data write-back is illustrated below in Table 4. In this example, the write-back target can be a different location based on a department or a geographic location code. This use case may be referred to as distributed data write-back. Table 4 shows the target definition for this example:

TABLE 4

| Data Item | | |
|---|---|---|
| Attribute | Description | |
| Unique Keys | Source Primary Keys | Target Primary Keys |
| | [Query1].[Order ID] | [Query1].[Aux Order ID] |
| | [Query1].[Order Item ID] | [Query1].[Aux Order Item ID] |

| | |
|---|---|
| Target Data | [Query1].[AUX Order Method Code / Item Code] |
| Column | |

The target data item is a data expression consisting of two query items. Each query item may represent a different location in a separate database.

Another example use case for virtual data write-back is illustrated below in Table 5. This example involves a business event driven data write-back. BI reporting tool 22 may not limit the source and target logic, in some examples. Instead, BI reporting tool 22 may enable source and target logic to be business driven with a set of business rules, for example to be implemented by a function (e.g., a function “Foo” in this example). BI reporting tool 22 therefore enables a user to edit or modify a data field to include a function that implements or executes an algorithm or set of instructions, rather than enabling the user to modify the data field only to enter a modified item of static data, in this example. The function may implement an algorithm or other set of executable instructions, and may also include one or more items of data, which may be acted upon by the algorithm or instructions. While the example of a function is discussed here, the function may take the form of or be replaced by any other form of executable instructions, such as a process, a method, a subroutine, executable data (in functional programming), or any other type of instructions, any of which may be generically referred to as a “function” for purposes of this disclosure. The function may include instructions to process or generate an output based at least in part on the original item of data in the original data source in accordance with one or more defined business rules, for example.

TABLE 5

| Data Item | | |
|---|---|---|
| Attribute | Description | |
| Unique Keys | Source Primary Keys | Target Primary Keys |
| | [Query1].[Order ID] | [Query1].[Aux Order ID] |
| | [Query1].[Order Item ID] | [Query1].[Aux Order Item ID] |
| Target Data | Call function Foo | |
| Column | | |

BI reporting tool 22 may also enable data write-back with HTML output, in some examples. An example HTML fragment from a report output in HTML format may be as follows:

<td class=“c_NS_37 lc” cid=“2” uid=“37” name=“c_NS_37”
type=“datavalue”>
<select onchange=“addChange(‘Query1’,{‘ Aux Order ID’:‘2110’,
‘ Aux Order Item

ID’:‘999’}, ‘AUX Order Method Code’, ‘3’, this.value);”

<option value=“1”>Fax</option>
<option value=“2”>Telephone</option>
<option value=“4”>E-mail</option>
<option value=“5”>Web</option>
<option value=“6”>Sales visit</option>
<option value=“3” SELECTED>Mail</option></select>

</td>

BI reporting tool 22 may also use an application programming interface (API) to help enable virtual data write-backs in a BI report. An example API specification for supporting virtual data write-backs in a BI report, for an API named “AddChange,” is shown in Table 6:

TABLE 6
API Specification

| | |
|---|---|
| AddChange | Name |
| ‘Query1’ | Query the change is based on |
| {‘Aux Order ID’:‘2110’, ‘Aux Order | Target Primary Keys |
| Item ID’:‘999’} | |
| ‘AUX Order Method Code’ | Target Column |
| ‘3’ | Current Value |
| This.value | Value changed by users |

In this example, the AddChange API may track changes entered by a user and puts the user changes into a local cache, such as a local JavaScript cache. When a user inputs a save command (e.g., clicks a save button), BI reporting tool 22 may send the cache to a server as a POST form HTTP variable. If the user leaves the current page of the BI report without entering a save command (and if an automatic save feature is not active), BI reporting tool 22 may clear the cache, effectively performing an undo on any entered user changes, in this example. Also, if a user enters a command to rerun a report, without first saving any changed values, BI reporting tool 22 may clears the local cache.

BI reporting tool 22 may use a current value to track if a user enters a change after the data is retrieved. If the current value is changed in the database, a database rollback may be performed. This technique may guarantee the safety of the data transaction.

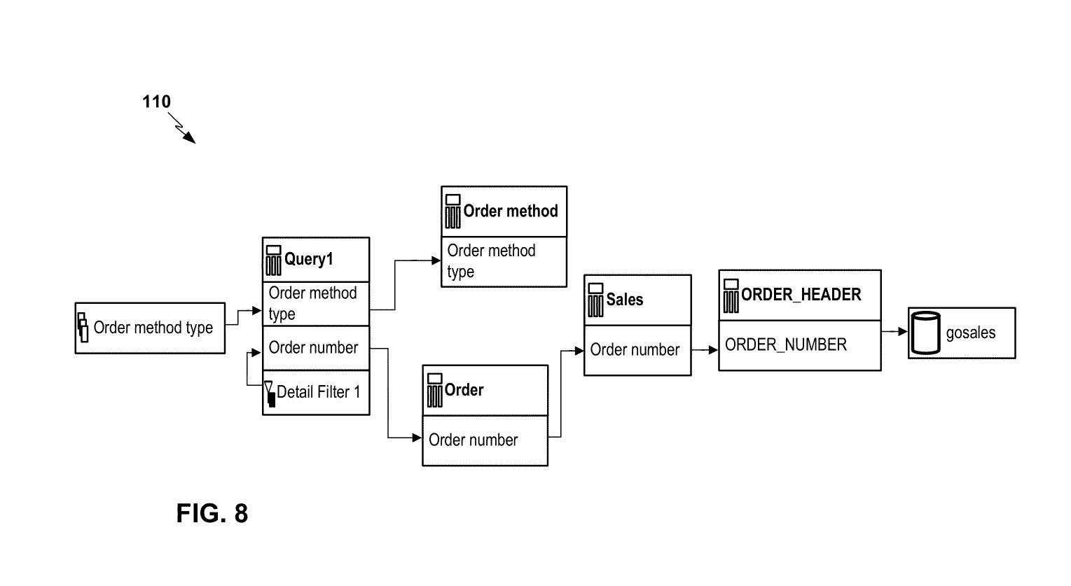

FIG. 8 depicts a data structure diagram 110 for a data write-back service of this disclosure, according to one example. How to identify a unique set of keys and data column to write the changes back into a database are described above. However, these expressions are from the report specification, and may be converted to physical layer in order to generate a native database query (e.g., in SQL). BI reporting tool 22 may convert these business layer terms to a physical database table name and column name. BI reporting tool 22 may query a data source using an API request that can return a database expression from a report expression. BI reporting tool 22 may, for example, use an API request in the form of a SOAP message (i.e., a message conforming to the World Wide Web Consortium SOAP protocol), as in the following example:

<lineageRequest version=“0.1”>

<connection>

<param

name=“searchPath”>/content/folder[@name=‘Samples’]/folder[@name=‘Models’]/packag
e[@name=‘GO Sales (query)’]/folder[@name=‘Report Studio Report
Samples’]/report[@name=‘WriteBackSample’]</param>

</connection>
<objectQuery id=“1”>

<param name=“queryName”> Query1</param>
<param name=“dataItemName”> [Query1].[Order method type]</param>

</objectQuery>

</lineageRequest>

This SOAP message may return the following expression:

#‘[gosales].[ORDER_METHOD].[ORDER_METHOD_‘+

$Language_lookup{$runLocale}+ ’] ’#

This expression may convey the following information:

| | |
|---|---|
| [ORDER_METHOD] | Table name |

| | |
|---|---|
| [ORDER_METHOD_‘+ $Language_lookup{$runLocale}+ ’] | Column |
| | Name |

Using this information, in this example, may yield the physical table column and query item relationship as shown below in Table 7:

TABLE 7

| Query Item | Physical Table Column |
|---|---|
| [Query1].[Aux Order ID] | [ORDER_DETAIL].[ORDER_ID] |
| [Query1].[Aux Order Item ID] | [ORDER_DETAIL].[ORDER_ITEM] |
| [ORDER_DETAIL]. | [ORDER_DETAIL]. |
| [ORDER_METHOD_CD] | [ORDER_METHOD_CD] |

With proper database locking, BI reporting tool 22 may issue the following database query (e.g., in SQL) to check if the value to potentially change has already been changed by a previous user.

SELECT COUNT(*) FROM ORDER_DETAIL

WHERE ORDER_ID=‘2110’ and ORDER_ITEM=‘999’

and ORDER_METHOD_ID=3 (3 is the original value)

If the count return is zero, this means the data is changed. BI reporting tool 22 may then respond by rolling back the update request and notifying the user. If the return is 1, this indicates the order method has not changed, and it is safe to make an update. BI reporting tool 22 may then issue the following database input (e.g., in SQL):

UPDATE ORDER_DETAIL

SET ORDER_METHOD_CD=this.value (this is the new value that we just changed)

WHERE ORDER_ID=‘2110’ and ORDER_ITEM=‘999’

BI reporting tool 22 may release the database lock as needed. BI reporting tool 22 may include either or both of client-side/UI components and server-side components that enable a BI report author to enable query-based virtual data write-back. This may include BI reporting tool 22 adding data write-back attributes on an existing query defined in a BI report specification used by BI reporting tool 22. The source information may include one or more source unique key expressions and source data expressions, and the destination information may include one or more unique key expressions and target source data expressions. The expressions may be query based on top of the metadata model, independent of physical databases, and the expressions may be evaluated based on runtime information.

BI reporting tool 22 may therefore enable data write-back to different data sources depending on conditions. That is, BI reporting tool 22 may run a BI report a first time with the BI report data source read only, and in subsequent runs, BI reporting tool 22 may use data expressions to enable the BI report data source to be writable. BI reporting tool 22 may further enable different data write-back destinations, based on options a user may select when authoring a BI report specification and designating write-back enabled fields in the BI report specification.

BI reporting tool 22 may therefore enable a virtual data write-back experience when a BI report data source is read-only or when users are not allowed to change the source data. BI reporting tool 22 can perform virtual data write-back to multiple database server locations if required, which may be based on geo codes, for example. This virtual data write-back capability can enable BI reports to become interactive, and enable users to analyze the results of modifying data in a BI report or exploring the results of projected or hypothetical changes to the data in a BI report.

BI reporting tool 22 may enable a user to alternate a BI report between ready-only and data write-back enabled. BI reporting tool 22 may also provide a set of keys to uniquely identify a data change item in a BI report, to reinforce the distinction between the read-only form of the report and the data write-back modified form of the report. BI reporting tool 22 also enables a separation between a data source and a virtual write-back target as an alternative data repository to the original data source, such that a data item can be written to the virtual data write-back target and appear to modify the data in the BI report without altering the underlying data source. BI reporting tool 22 may also use a one to one relationship or a many to many relationship among data repositories in different examples, and dynamically determine data source and virtual data target locations at design time or at runtime.

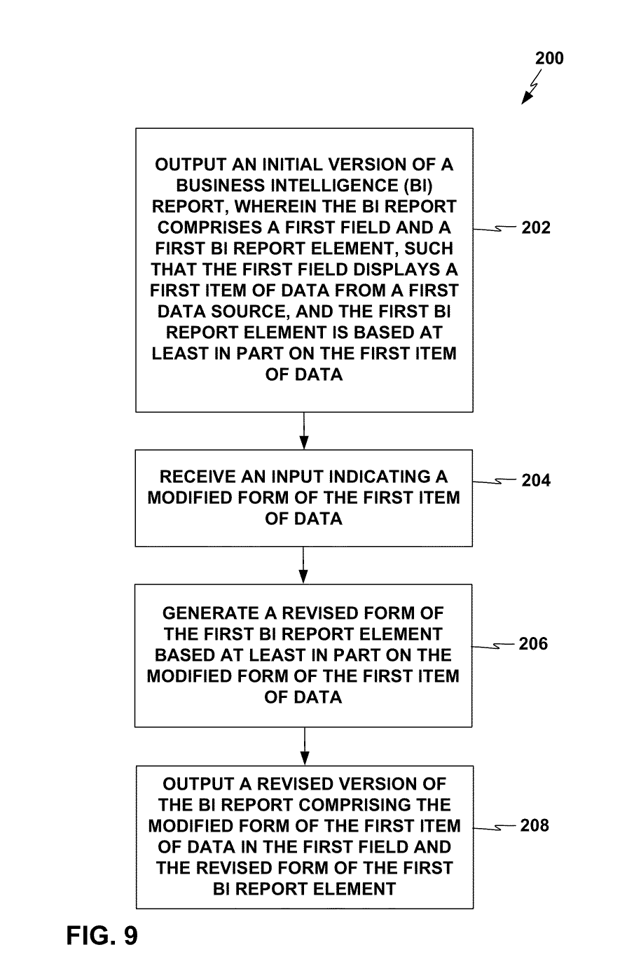

FIG. 9 depicts a flowchart for an example overall process 200 that BI reporting tool 22, executing on one or more computing devices (e.g., servers, computers, processors, etc.), may perform in one example. The description of FIG. 9 refers to certain elements and figures for purposes of illustration, and are not limiting to any one particular example. BI reporting tool 22 may output an initial version of a business intelligence (BI) report, wherein the BI report comprises a first field and a first BI report element, such that the first field displays a first item of data from a first data source, and the first BI report element is based at least in part on the first item of data (e.g., data field 52 in BI reporting UI 50 of FIG. 4) (202). BI reporting tool 22 may receive an input indicating a modified form of the first item of data (e.g., user inputs to data field 52, or computer-generated inputs, e.g., from another application or service, to data field 52) (204). BI reporting tool 22 may generate a revised form of the first BI report element based at least in part on the modified form of the first item of data (206). BI reporting tool 22 may output a revised version of the BI report comprising the modified form of the first item of data in the first field and the revised form of the first BI report element (208).

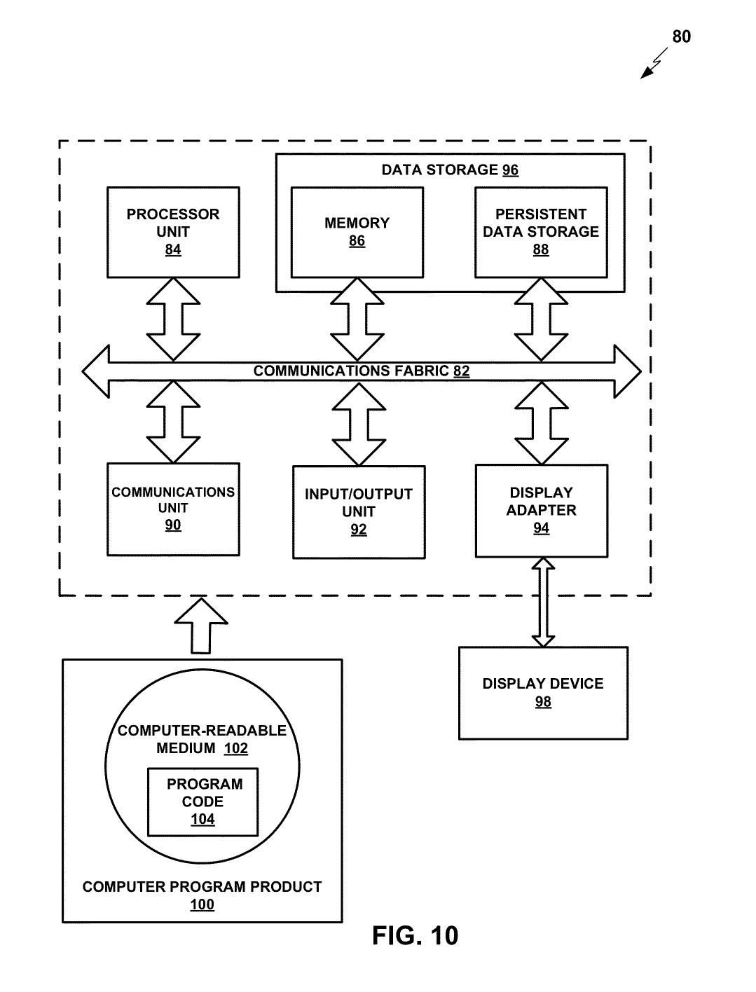

FIG. 10 is a block diagram of an example computing device 80 that may be used to execute a BI reporting tool 22, according to an illustrative example. Computing device 80 may be a server such as one of web servers 14A or application servers 14B as depicted in FIG. 2. Computing device 80 may also be any server for providing an enterprise business intelligence application in various examples, including a virtual server that may be run from or incorporate any number of computing devices. A computing device may operate as all or part of a real or virtual server, and may be or incorporate a workstation, server, mainframe computer, notebook or laptop computer, desktop computer, tablet, smartphone, feature phone, or other programmable data processing apparatus of any kind Other implementations of a computing device 80 may include a computer having capabilities or formats other than or beyond those described herein.

In the illustrative example of FIG. 10, computing device 80 includes communications fabric 82, which provides communications between processor unit 84, memory 86, persistent data storage 88, communications unit 90, and input/output (I/O) unit 92. Communications fabric 82 may include a dedicated system bus, a general system bus, multiple buses arranged in hierarchical form, any other type of bus, bus network, switch fabric, or other interconnection technology. Communications fabric 82 supports transfer of data, commands, and other information between various subsystems of computing device 80.

Processor unit 84 may be a programmable central processing unit (CPU) configured for executing programmed instructions stored in memory 86. In another illustrative example, processor unit 84 may be implemented using one or more heterogeneous processor systems in which a main processor is present with secondary processors on a single chip. In yet another illustrative example, processor unit 84 may be a symmetric multi-processor system containing multiple processors of the same type. Processor unit 84 may be a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processor unit 84 may include a multi-core processor, such as a dual core or quad core processor, for example. Processor unit 84 may include multiple processing chips on one die, and/or multiple dies on one package or substrate, for example. Processor unit 84 may also include one or more levels of integrated cache memory, for example. In various examples, processor unit 84 may comprise one or more CPUs distributed across one or more locations.

Data storage 96 includes memory 86 and persistent data storage 88, which are in communication with processor unit 84 through communications fabric 82. Memory 86 can include a random access semiconductor memory (RAM) for storing application data, i.e., computer program data, for processing. While memory 86 is depicted conceptually as a single monolithic entity, in various examples, memory 86 may be arranged in a hierarchy of caches and in other memory devices, in a single physical location, or distributed across a plurality of physical systems in various forms. While memory 86 is depicted physically separated from processor unit 84 and other elements of computing device 80, memory 86 may refer equivalently to any intermediate or cache memory at any location throughout computing device 80, including cache memory proximate to or integrated with processor unit 84 or individual cores of processor unit 84.

Persistent data storage 88 may include one or more hard disc drives, solid state drives, flash drives, rewritable optical disc drives, magnetic tape drives, or any combination of these or other data storage media. Persistent data storage 88 may store computer-executable instructions or computer-readable program code for an operating system, application files comprising program code, data structures or data files, and any other type of data. These computer-executable instructions may be loaded from persistent data storage 88 into memory 86 to be read and executed by processor unit 84 or other processors. Data storage 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical, tangible, non-transitory computer-readable data storage devices. Data storage 96 may include any of various forms of volatile memory that may require being periodically electrically refreshed to maintain data in memory, while those skilled in the art will recognize that this also constitutes an example of a physical, tangible, non-transitory computer-readable data storage device. Executable instructions may be stored on a non-transitory medium when program code is loaded, stored, relayed, buffered, or cached on a non-transitory physical medium or device, including if only for only a short duration or only in a volatile memory format.

Processor unit 84 can also be suitably programmed to read, load, and execute computer-executable instructions or computer-readable program code for a BI reporting tool 22, as described in greater detail above. This program code may be stored on memory 86, persistent data storage 88, or elsewhere in computing device 80. This program code may also take the form of program code 104 stored on computer-readable medium 102 comprised in computer program product 100, and may be transferred or communicated, through any of a variety of local or remote means, from computer program product 100 to computing device 80 to be enabled to be executed by processor unit 84, as further explained below.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, or any other suitable operating system. Processor unit 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a LAN 16, an Ethernet adapter, a Token Ring adapter, a modem for connecting to a transmission system such as a telephone line, or any other type of communication interface. Communications unit 90 can be used for operationally connecting many types of peripheral computing devices to computing device 80, such as printers, bus adapters, and other computers. Communications unit 90 may be implemented as an expansion card or be built into a motherboard, for example.

The input/output unit 92 can support devices suited for input and output of data with other devices that may be connected to computing device 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. It will be understood that some of these examples may overlap with each other, or with example components of communications unit 90 or data storage 96. Input/output unit 92 may also include appropriate device drivers for any type of external device, or such device drivers may reside elsewhere on computing device 80 as appropriate.

Computing device 80 also includes a display adapter 94 in this illustrative example, which provides one or more connections for one or more display devices, such as display device 98, which may include any of a variety of types of display devices. It will be understood that some of these examples may overlap with example components of communications unit 90 or input/output unit 92. Input/output unit 92 may also include appropriate device drivers for any type of external device, or such device drivers may reside elsewhere on computing device 80 as appropriate. Display adapter 94 may include one or more video cards, one or more graphics processing units (GPUs), one or more video-capable connection ports, or any other type of data connector capable of communicating video data, in various examples. Display device 98 may be any kind of video display device, such as a monitor, a television, or a projector, in various examples.

Input/output unit 92 may include a drive, socket, or outlet for receiving computer program product 100, which comprises a computer-readable medium 102 having computer program code 104 stored thereon. For example, computer program product 100 may be a CD-ROM, a DVD-ROM, a Blu-Ray disc, a magnetic disc, a USB stick, a flash drive, or an external hard disc drive, as illustrative examples, or any other suitable data storage technology.

Computer-readable medium 102 may include any type of optical, magnetic, or other physical medium that physically encodes program code 104 as a binary series of different physical states in each unit of memory that, when read by computing device 80, induces a physical signal that is read by processor 84 that corresponds to the physical states of the basic data storage elements of storage medium 102, and that induces corresponding changes in the physical state of processor unit 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 84, thereby physically causing or configuring processor unit 84 to generate physical outputs that correspond to the computer-executable instructions, in a way that causes computing device 80 to physically assume new capabilities that it did not have until its physical state was changed by loading the executable instructions comprised in program code 104.

In some illustrative examples, program code 104 may be downloaded over a network to data storage 96 from another device or computer system for use within computing device 80. Program code 104 comprising computer-executable instructions may be communicated or transferred to computing device 80 from computer-readable medium 102 through a hard-line or wireless communications link to communications unit 90 and/or through a connection to input/output unit 92. Computer-readable medium 102 comprising program code 104 may be located at a separate or remote location from computing device 80, and may be located anywhere, including at any remote geographical location anywhere in the world, and may relay program code 104 to computing device 80 over any type of one or more communication links, such as the Internet and/or other packet data networks. The program code 104 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 104 may be transmitted from a source computer-readable medium 102 over non-tangible media, such as communications links or wireless transmissions containing the program code 104. Program code 104 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 80.

As will be appreciated by a person skilled in the art, aspects of the present disclosure may be embodied as a method, a device, a system, or a computer program product, for example. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer-readable data storage devices or computer-readable data storage components that include computer-readable medium(s) having computer readable program code embodied thereon. For example, a computer-readable data storage device may be embodied as a tangible device that may include a tangible data storage medium (which may be non-transitory in some examples), as well as a controller configured for receiving instructions from a resource such as a central processing unit (CPU) to retrieve information stored at one or more particular addresses in the tangible, non-transitory data storage medium, and for retrieving and providing the information stored at those particular one or more addresses in the data storage medium.

The data storage device may store information that encodes both instructions and data, for example, and may retrieve and communicate information encoding instructions and/or data to other resources such as a CPU, for example. The data storage device may take the form of a main memory component such as a hard disc drive or a flash drive in various embodiments, for example. The data storage device may also take the form of another memory component such as a RAM integrated circuit or a buffer or a local cache in any of a variety of forms, in various embodiments. This may include a cache integrated with a controller, a cache integrated with a graphics processing unit (GPU), a cache integrated with a system bus, a cache integrated with a multi-chip die, a cache integrated within a CPU, or the processor registers within a CPU, as various illustrative examples. The data storage apparatus or data storage system may also take a distributed form such as a redundant array of independent discs (RAID) system or a cloud-based data storage service, and still be considered to be a data storage component or data storage system as a part of or a component of an embodiment of a system of the present disclosure, in various embodiments.

Any combination of one or more computer readable medium(s) may be utilized. The computer readable medium may be a computer readable signal medium or a computer readable storage medium. A computer readable storage medium may be, for example, but is not limited to, a system, apparatus, or device used to store data, but does not include a computer readable signal medium. Such system, apparatus, or device may be of a type that includes, but is not limited to, an electronic, magnetic, optical, electromagnetic, infrared, electro-optic, heat-assisted magnetic, or semiconductor system, apparatus, or device, or any suitable combination of the foregoing. A non-exhaustive list of additional specific examples of a computer readable storage medium includes the following: an electrical connection having one or more wires, a portable computer diskette, a hard disc, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device, for example.

Program code embodied on a computer readable medium may be transmitted using any appropriate medium, including but not limited to radio frequency (RF) or other wireless, wire line, optical fiber cable, etc., or any suitable combination of the foregoing. Computer program code for carrying out operations for aspects of the present disclosure may be written in any combination of one or more programming languages, including an object oriented programming language such as Java, Smalltalk, C++, or the like, or other imperative programming languages such as C, or functional languages such as Common Lisp, Haskell, or Clojure, or multi-paradigm languages such as C#, Python, or Ruby, among a variety of illustrative examples. One or more sets of applicable program code may execute partly or entirely on the user's desktop or laptop computer, smartphone, tablet, or other computing device; as a stand-alone software package, partly on the user's computing device and partly on a remote computing device; or entirely on one or more remote servers or other computing devices, among various examples. In the latter scenario, the remote computing device may be connected to the user's computing device through any type of network, including a local area network (LAN) or a wide area network (WAN), or the connection may be made to an external computer (for example, through a public network such as the Internet using an Internet Service Provider), and for which a virtual private network (VPN) may also optionally be used.

In various illustrative embodiments, various computer programs, software applications, modules, or other software elements may be executed in connection with one or more user interfaces being executed on a client computing device, that may also interact with one or more web server applications that may be running on one or more servers or other separate computing devices and may be executing or accessing other computer programs, software applications, modules, databases, data stores, or other software elements or data structures. A graphical user interface may be executed on a client computing device and may access applications from the one or more web server applications, for example. Various content within a browser or dedicated application graphical user interface may be rendered or executed in or in association with the web browser using any combination of any release version of HTML, CSS, JavaScript, and various other languages or technologies. Other content may be provided by computer programs, software applications, modules, or other elements executed on the one or more web servers and written in any programming language and/or using or accessing any computer programs, software elements, data structures, or technologies, in various illustrative embodiments.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Aspects of the present disclosure are described herein with reference to flowchart illustrations and/or block diagrams of methods, apparatus, systems, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, may create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices, to produce a computer-implemented process such that the instructions that execute on the computer or other programmable apparatus provide or embody processes for implementing the functions or acts specified in the flowchart and/or block diagram block or blocks.

The flowchart and block diagrams in the figures illustrate the architecture, functionality, and operation of possible implementations of devices, methods and computer program products according to various embodiments of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may be executed in a different order, or the functions in different blocks may be processed in different but parallel processing threads, depending upon the functionality involved. Each block of the block diagrams and/or flowchart illustration, and combinations of blocks in the block diagrams and/or flowchart illustration, may be implemented by special purpose hardware-based systems that perform the specified functions or acts, or combinations of executable instructions, special purpose hardware, and general-purpose processing hardware.

The description of the present disclosure has been presented for purposes of illustration and description, and is not intended to be exhaustive or limited to the disclosure in the form disclosed. Many modifications and variations will be understood by persons of ordinary skill in the art based on the concepts disclosed herein. The particular examples described were chosen and disclosed in order to explain the principles of the disclosure and example practical applications, and to enable others of ordinary skill in the art to understand the disclosure for various embodiments with various modifications as are suited to the particular use contemplated. The various examples described herein and other embodiments are within the scope of the following claims.

What is claimed is:

1. A method for enabling virtual data write-back in a business intelligence (BI) reporting tool, the method comprising:
outputting an initial version of a business intelligence (BI) report, wherein the BI report comprises a first field and a first BI report element, such that the first field displays a first item of data from a first data source, and the first BI report element is based at least in part on the first item of data;
receiving an input indicating a modified form of the first item of data;
generating a revised form of the first BI report element based at least in part on the modified form of the first item of data; and
outputting a revised version of the BI report comprising the modified form of the first item of data in the first field and the revised form of the first BI report element.

2. The method of claim 1, further comprising:
storing the modified form of the first item of data in a data write-back location separate from the first data source.

3. The method of claim 2, wherein the data write-back location is one of one or more data write-back locations separate from the first data source, the method further comprising:
storing the modified form of the first item of data in the one or more data write-back locations based at least in part on a target data expression.

4. The method of claim 1, further comprising:
associating a unique source key with the first item of data in the first data source; and
associating a unique target key with the modified form of the first item of data in a data write-back location separate from the first data source.

5. The method of claim 4,
wherein outputting the initial version of the BI report comprises referencing the unique source key to display, in the first field, the first item of data from the first data source.

6. The method of claim 4,
wherein outputting the revised version of the BI report comprises referencing the unique target key to display, in the first field, the modified form of the first item of data from the data write-back location.

7. The method of claim 1, further comprising:
associating a unique source key with the first item of data in the first data source; and
associating a unique target key with the modified form of the first item of data in a data write-back location, wherein the unique target key comprises a concatenation of two or more unique source keys in the first data source.

8. The method of claim 1, further comprising:
storing the modified form of the first item of data in a data write-back source, wherein the data write-back source comprises a data source query expression that may resolve either to a location in the first data source or a virtual write-back data source.

9. The method of claim 1, further comprising:
storing the modified form of the first item of data in a virtual write-back data source that comprises a metadata model executing in an application layer.

10. The method of claim 1, further comprising:
storing the modified form of the first item of data in a virtual write-back data source that comprises a function may include instructions to generate an output based at least in part on the original item of data in the original data source.

11. The method of claim 1, further comprising, in response to an input selecting a store option, storing the revised version of the BI report comprising the modified form of the first item of data in the first field and the revised form of the first BI report element, and a unique source key associating the first item of data from the first data source, with a user-selectable option to restore the first item of data from the first data source to the first field.

12. The method of claim 1, wherein the BI report comprises one or more additional fields that display one or more respective additional items of data from one or more data sources, and the first BI report element is further based at least in part on the one or more respective additional items of data, the method further comprising:
receiving one or more inputs indicating modified forms of the one or more respective additional items of data;
generating the revised form of the first BI report element based at least in part on the modified forms of the one or more respective additional items of data; and
outputting the revised version of the BI report comprising the modified form of the first item of data in the first field and the revised form of the first BI report element.

13. The method of claim 12, wherein the BI report comprises one or more additional BI report elements based at least in part on the one or more respective additional items of data, the method further comprising:
generating revised forms of the one or more additional BI report elements based at least in part on the modified forms of the one or more respective additional items of data,
wherein the revised version of the BI report comprises the revised forms of the one or more additional BI report elements.

14. The method of claim 1, further comprising:
receiving a subsequent input indicating a subsequent modified form of the first item of data;
generating a subsequent revised form of the first BI report element based at least in part on the subsequent modified form of the first item of data; and
outputting the subsequent revised version of the BI report comprising the subsequent modified form of the first item of data in the first field and the subsequent revised form of the first BI report element.

15. The method of claim 1, wherein receiving the input indicating the modified form of the first item of data comprises receiving a user input via a user interface.
